(19) United States
(12) Patent Application Publication
(10) Pub. No.: US 2012/0262375 A1
(43) Pub. Date: Oct. 18, 2012

(54) Computer mouse

(76) Inventor: Ricardo A. Tello, Sante Fe Springs, CA (US)

(21) Appl. No.: 13/068,872

(22) Filed: Jan. 13, 2009

Related U.S. Application Data
(60) Provisional application No. 61/201,663, filed on Dec. 12, 2008.

(51) Int. Cl. G06F 3/033

(52) U.S. Cl. 345/163

(57) ABSTRACT

The present invention is a computer mouse that has a plurality of clickable buttons and a scroll wheel. A calculator is embedded in the mounse, wherein the calculator has a display and keys. The mouse also has a slidable cover that can optionally cover the calculator display and keys or the mouse buttons and scroll wheel; wherein, the cover has a top surface with a substantial branding area. In the preferred embodiment, the substantial branding area is a sunken surface. The sunken surface comprises most of the top surface of said slidable cover, generally at least 80% of said top surface of the slidable cover. The sunken surface can be filled by a label and an epoxy dome.

### CROSS-REFERENCE TO RELATED APPLICATIONS

The applicant hereby claims benefit of U.S. Provisional Patent Application No. 61/201,663 (filed Dec. 12, 2008). The specification of said provisional patent application is incorporated herein by this reference as though set forth in full.

### STATEMENT REGARDING FEDERALLY SPONSORED RESEARCH OR DEVELOPMENT

Not Applicable

### FIELD OF INVENTION

The present invention relates to computer input devices.

### BACKGROUND OF THE INVENTION

The present invention is a computer mouse with a calculator. A computer mouse is a small device that a computer user pushes across a desk surface in order to point to a place on a display screen and to select one or more actions to take from that position. The mouse first became a widely-used computer tool when Apple Computer made it a standard part of the Apple Macintosh. Today, the mouse is an integral part of the graphical user interface (GUI) of any personal computer. The mouse apparently got its name by being about the same size and color as a toy mouse.

A mouse can consist of a metal or plastic housing or casing, a ball that sticks out of the bottom of the casing and is rolled on a flat surface, one or more buttons on the top of the casing, and a cable that connects the mouse to the computer. As the ball is moved over the surface in any direction, a sensor sends impulses to the computer that causes a mouse-responsive program to reposition a visible indicator (called a cursor) on the display screen. The positioning is relative to some variable starting place. Viewing the cursor's present position, the user readjusts the position by moving the mouse.

Modern surface-independent optical mice work by using an optoelectronic sensor to take successive pictures of the surface on which the mouse operates. As computing power grew cheaper, it became possible to embed more powerful special-purpose image-processing chips in the mouse itself. This advance enabled the mouse to detect relative motion on a wide variety of surfaces, translating the movement of the mouse into the movement of the pointer and eliminating the need for a special mouse-pad. This advance paved the way for widespread adoption of optical mice. Optical mice illuminate the surface that they track over, using an LED or a laser diode. Changes between one frame and the next are processed by the image processing part of the chip and translated into movement on the two axes using an optical flow estimation algorithm. For example, the Avago Technologies ADNS-2610 optical mouse sensor processes 1512 frames per second: each frame consisting of a rectangular array of 18×18 pixels, and each pixel can sense 64 different levels of gray. Some newer optical mice including some from Logitech's LX series use an infrared sensor instead of a light emitting diode. This saves power and can be more accurate.

The laser mouse uses an infrared laser diode instead of an LED to illuminate the surface beneath their sensor. As early as 1998, Sun Microsystems provided a laser mouse with their Sun SPARCstation servers and workstations.[24] However, laser mice did not enter the mainstream market until 2004, when Logitech, in partnership with Agilent Technologies, introduced its MX 1000 laser mouse. This mouse uses a small infrared laser instead of an LED and has significantly increased the resolution of the image taken by the mouse. The laser enables around 20 times more surface tracking power to the surface features used for navigation compared to conventional optical mice, via interference effects. All of the various mouse devices described above can be used in the present invention.

The most conventional kind of mouse has two buttons on top: the left one is used most frequently. In the Windows operating systems, it lets the user click once to send a “Select” indication that provides the user with feedback that a particular position has been selected for further action. The next click on a selected position or two quick clicks on it causes a particular action to take place on the selected object. For example, in Windows operating systems, it causes a program associated with that object to be started. The second button, on the right, usually provides some less-frequently needed capability. For example, when viewing a Web page, you can click on an image to get a popup menu that, among other things, lets you save the image on your hard disk. Some mouses have a third button for additional capabilities. Some mouse manufacturers also provide a version for left-handed people.

Windows 95 and other operating systems let the user adjust the sensitivity of the mouse, including how fast it moves across the screen, and the amount of time that must elapse within a “double click.” In some systems, the user can also choose among several different cursor appearances. Some people use a mousepad to improve traction for the mouse ball.

Although the mouse has become a familiar part of the personal computer, its design continues to evolve and there continue to be other approaches to pointing or positioning on a display. Notebook computers include built-in mouse devices that let you control the cursor by rolling your finger over a built-in trackball. IBM's ScrollPoint mouse adds a small “stick” between two mouse buttons that lets you scroll a Web page or other content up or down and right or left. Users of graphic design and CAD applications can use a stylus and a specially-sensitive pad to draw as well as move the cursor. Other display screen-positioning ideas include a video camera that tracks the user's eye movement and places the cursor accordingly.

A calculator is a device for performing mathematical calculations, distinguished from a computer by having a limited problem solving ability and an interface optimized for interactive calculation rather than programming. Calculators can be hardware or software, and mechanical or electronic, and are often built into devices such as PDAs or mobile phones.

Modern electronic calculators are generally small, digital, (often pocket-sized) and usually inexpensive. In addition to general purpose calculators, there are those designed for specific markets; for example, there are scientific calculators which focus on advanced math like trigonometry and statistics, or even have the ability to do computer algebra. Modern calculators are more portable than most computers, though most PDAs are comparable in size to handheld calculators.

The basic components of a calculator are old in the art. In the past, it has been the practice to mount an arithmetic unit in the form of an integrated circuit package on the printed circuit board and electrically connected to the keyboard and to a display driver unit. U.S. Pat. Nos. 4,096,577, 3,978,328, 4,012,725, 4,041,295, 4,064,398, and 4,078,257 describe calculator technologies that can be used in the present invention. The specification of each of said US patents is incorporated herein by this reference as though set forth in full.

### SUMMARY OF THE INVENTION

The present invention is a computer mouse that has a plurality of clickable buttons and a scroll wheel. A calculator is embedded in the mounse, wherein the calculator has a display and keys. The mouse also has a slidable cover that can optionally cover the calculator display and keys or the mouse buttons and scroll wheel; wherein, the cover has a top surface with a substantial branding area.

In the preferred embodiment, the substantial branding area is a sunken surface. The sunken surface comprises most of the top surface of said slidable cover, generally at least 80% of said top surface of the slidable cover. The sunken surface can be filled by a label and an epoxy dome.

### BRIEF DESCRIPTION OF THE DRAWINGS

The above and other objects and advantages of the present invention will be apparent upon consideration of the following detailed description, taken in conjunction with the accompanying drawings, in which reference characters refer to like parts throughout, and in which:

FIG. 1 shows the present invention.

### DETAILED DESCRIPTION OF THE INVENTION

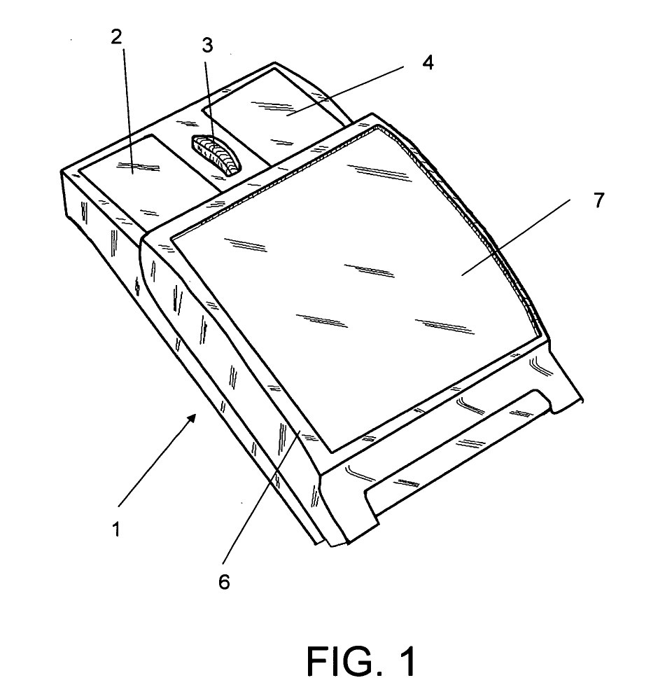

FIG. 1 shows the present invention 1. The present invention comprises a computer mouse that can be connected to a computer. In the preferred embodiment, the mouse is wireless and no physical connection between the computer and the mouse is required for operation. In the preferred embodiment, the bottom surface is flat, except for functional features such as an LED, connection button or functional labeling.

The mouse has a left button 2. In the preferred embodiment, a user can click on the left button to select and perform other operations commonly permitted by the left buttons on two-buttoned devices. In addition, the mouse has a scroll wheel 3 that allows the user to scroll on the computer. The scroll wheel, a notably different form of mouse-button, consists of a small wheel that the user can rotate to provide immediate one-dimensional input. Usually, this input translates into “scrolling” up or down within the active window or GUI-element. In the preferred embodiment, the wheel can be clicked to act as a third mouse button.

Further, the mouse has a right button 4. In the preferred embodiment, a user can click on the right button 4 to open various menus available to the user (depending on the placement of the cursor on the screen).

The present invention also comprises a slidable cover 6. The slidable cover comprises a top surface that includes a substantial branding area 7. In the preferred embodiment, this branding area is a surface sunken into the top surface of the cover. In the preferred embodiment, the depth of the branding area is about 1 mm. Typically, the branding area is substantially rectangular with rounded corners. Advertising, trademarks and other product or company information can be imprinted or otherwise marked on the front branding area. The branding area can also be utilized by a user to hold a photograph. The device might come with a clear, plastic cover to protect the photograph. In the preferred embodiment, the branding area 7 takes up most of the surface of the cover 6. In fact, it is preferred that the branding area 7 takes up at least 80% of the surface area of the top surface of the cover. Moving the slidable cover 6 reveals the calculator. The calculator has buttons and a display, as can be seen below. In the preferred embodiment, the mouse is wireless.

The calculator has a display, number keys (“1”, “2”, etc.) and function keys (“+”, “=”, etc.) as are found in any typical calculator. As can also be seen, the body of the mouse has slots 9 on the sides to engage and guide the cover 6. When the cover is moved forward to reveal the calculator, it covers the mouse buttons and scroll wheel.

The cover 6 is arched so that, as it moves forward, the forward edge also moves downward. The mouse buttons are on a downward slope moving forward. The cover is raised up from the mouse sufficiently for it to cover the raised scroll wheel.

One of ordinary skill in the art will appreciate that the techniques, structures and methods of the present invention above are exemplary. The present invention can be implemented in various embodiments without deviating from the scope of the invention.

1. A computer mouse comprising: a computer mouse, said mouse comprising a plurality of clickable buttons and a scroll wheel; a calculator embedded in said mouse, wherein said calculator comprises a display and keys; a slidable cover that can optionally cover the calculator display and keys or the mouse buttons and scroll wheel; wherein, said cover comprises a top surface with a substantial branding area.

2. The computer mouse of claim 1, wherein said substantial branding area comprises a sunken surface.

3. The computer mouse of claim 2, wherein said sunken surface comprises most of the top surface of said slidable cover.

4. The computer mouse of claim 3, wherein said sunken surface comprises at least 80% of said top surface of said slidable cover.

5. The computer mouse of claim 4, wherein said branding area comprises a sunken surface that has been substantially filled by a label and an epoxy dome has been applied thereon.
